(19) United States
(12) Patent Application Publication
(10) Pub. No.: US 2001/0049615 A1
(43) Pub. Date: Dec. 6, 2001

(54) Method and apparatus for dynamic business management

(76) Inventors: Christopher L. Wong, San Jose, CA (US); John F. Zepecki, Los Gatos, CA (US); Edward L. Jackson, Redwood City, CA (US)

Correspondence Address: WILSON SONSINI GOODRICH & ROSATI, 650 PAGE MILL ROAD, PALO ALTO, CA, 943041050

(21) Appl. No.: 09/742,458

(22) Filed: Dec. 19, 2000

Related U.S. Application Data
(60) Provisional application No. 60/192,201, filed on Mar. 27, 2000.

(51) Int. Cl. G06F 17/60

(52) U.S. Cl. 705/8

(57) ABSTRACT

A method and apparatus for dynamic business management. One embodiment includes a method for workforce procurement and management using a hosted network application. The method comprises maintaining a plurality of modules accessible at varying levels to different participants in a workforce procurement and management process. The modules include: an exchange module comprising a search function; a fulfillment module comprising; a resource management module comprising a work journal function; a knowledge management module comprising a reporting function and an analysis function; and a supplier management module comprising a digital portfolio function. The method includes maintaining a database coupled to the plurality of modules.

### RELATED APPLICATIONS

This application claims priority from U.S. Provisional Application Ser. No. 60/192,201, filed Mar. 27, 2000, entitled Method and Apparatus For Dynamic Business Management.

### FIELD OF THE INVENTION

The invention is in the field of automated business management, and more particularly in the field of automated workforce management.

### BACKGROUND OF THE INVENTION

As the labor market undergoes a fundamental shift, the contingent workforce has become a strategic asset for many companies. Talent is the source of competitive advantage in the Digital Economy and skills shortages; employee mobility and choice are adversely impacting business sustainability.

Increasingly enterprises are hiring contractors to fill labor gaps, provide specialized expertise and manage staffing unpredictability, fueling the contingent workforce market. The increased usage of this talent pool amplifies the unresolved problems in finding, hiring and managing a contingent workforce. For many companies, contract workers are the fastest growing percentage of the workforce. The contingent workforce is expensive and the processes for managing these resources are inefficient and cumbersome.

Every year, corporations spend hundreds of millions of dollars trying to consolidate and improve their procurement functions for materials and goods in an effort to create efficiencies and cut costs. Most companies, however, fail to pay attention to the procurement of one of their most valuable resources—their contingent workforce.

As reliance upon information technology (IT) contractors grows, the speed of an organization to hire and utilize contingent workers in the most efficient manner becomes critical. The contingent workforce is a talent market with unique characteristics, creating new challenges for hiring managers and IT contractors. As usage increases, the permanent placement-hiring model no longer works with this particular “supply chain” of talent.

The contingent workforce market is a disconnected collection of IT contractors with specialized competencies. Unlike permanent employees, these workers are motivated by projects, not companies. They are loyal to their skills and have a strong need for independence and flexibility. IT contractors work for shorter intervals and have an ongoing need for new jobs. Furthermore, they must manage their own businesses and handle tax compliance, cash flow and bookkeeping. These workers require a different management philosophy, and a procurement process that is different from full-time employees.

Increasingly, forward-thinking enterprises consider their contingent workforce a strategic asset and an underpinning for business value, sustainability and competitiveness. As reliance upon contractors grows, the speed of an organization to find, hire and utilize contingent workers in the most efficient and cost effective manner becomes critical. The application of permanent placement hiring models to the unique nature of this workforce no longer works. The Internet offers the potential to significantly drive new levels of efficiency, speed and economics for deploying this strategic talent pool. Current Internet solutions, however, have significant limitations. For example, online bulletin boards, portals, skills marketplaces/exchanges and workforce management solutions do not focus exclusively on the contingent workforce. In addition, current Internet solutions do not drive fundamental improvements across the full skills procurement lifecycle, e.g., finding, hiring and managing of contract workers. Current solutions further fail to accumulate process and cost knowledge to make smarter hiring decisions.

### SUMMARY OF THE DISCLOSURE

A system and method for dynamic business management is disclosed. In various embodiments, the system includes hosted application services that provide a collaborative environment for the client, contractor, recruiter, and staffing supplier. According to one embodiment, the hosted application service provides functionality that encompasses the skills procurement process, including: skills fulfillment, skills exchange, supplier management, resource management, and knowledge management.

The system provides the ability to automatically match buyers and sellers based on buyer or seller preferences and business rules. The system provides a dynamic multi-attribute trading environment by allowing buyers and sellers to negotiate multiple attributes of the transaction. The system also provides the ability to personalize the system for the individual and/or the enterprise based on business criteria, such as filtering of candidates based on criteria, manipulating pricing information based on defined relationships, providing workflow capabilities and approvals. The system leverages historic data to predict behavior and create an experience anticipating what the user desires to do.

### BRIEF DESCRIPTION OF THE DRAWINGS

FIG. 1 is a diagram of one embodiment of a dynamic business management system.

FIG. 2 is a block diagram showing an embodiment of hosted application components accessible through a hosted management server.

FIG. 3 is an entity relationship diagram showing the relationships between the various entities within an embodiment of the hosted application.

FIG. 4 is a diagram showing an example lifecycle of a digital portfolio.

FIG. 5 is a process flow diagram that illustrates an example requirements fulfillment process.

FIG. 6 a process flow diagram showing an example skills exchange process.

FIG. 7 is a process flow diagram that illustrates an example work order approval process.

FIG. 8 is a process flow diagram that shows an example work journal approval process.

FIG. 9 is a process flow diagram that illustrates a settlement process.

FIG. 10 is a diagram of one embodiment of skills procurement platform architecture.

### DETAILED DESCRIPTION

A method and apparatus for dynamic business management is disclosed. Embodiments include a skills procurement platform built exclusively to address the unique challenges enterprises face in hiring and managing a contract workforce. The skills procurement platform is an integrated solution that drives fundamental improvements across the full skills procurement lifecycle-finding, hiring and managing-of contract resources. Embodiments include a “public skills marketplace” and a “private skills marketplace”. The public skills enterprise brings together the community of hiring managers, contractors, staffing agencies and their multi-step hiring processes via the World Wide Web), facilitating the efficient business-to-business exchange of skills and projects. The public skills marketplace aggregates supply (contractors) and demand (projects). The private skills marketplace includes, in one embodiment, a method for workforce procurement and management using a hosted network application, or extranet. The method comprises maintaining a plurality of modules accessible at varying levels to different participants in a workforce procurement and management process. The modules include: an exchange module including a search, sourcing, and transaction management function; a fulfillment module including the functions of skills requirements, request for proposal, work order, settlement, logistics management, fulfillment management, and risk management; a resource management module including a work journal function and expense reporting function, a knowledge management module including a reporting function and an analysis function; a supplier management module including a supplier network function and a digital portfolio function; and a supplier workbench module with a supplier workbench function that provides tools for automating the supply pool, such as portals to access the skills exchange, resource management, and knowledge management functions as well as implementation tools to assist with the profiling of contractors. The embodiment further includes a database coupled to the plurality of modules.

In various embodiments, the system includes hosted application services that provide a collaborative environment for the client, contractor, recruiter, and staffing supplier. For the purpose of explaining aspects of the invention, an example embodiment including a hosted extranet accessed by clients, recruiters, contractors, and staffing suppliers is described. Clients, as referred to herein, are employers, typically corporate entities, that use the extranet to manage aspects of their business such as workforce hiring and resource management. Clients use the extranet, for example, to search for qualified contractors to work on particular projects and to manage and monitor the work of their contingent workers. Contractors, as referred to herein, are professionals looking for work on a temporary basis. A contractor can work as an independent and contract directly with a client or can work through a staffing supplier. Recruiters, as referred to herein, are professionals responsible for managing the client's contractor resources and for fulfilling the client's resource requirements. Staffing suppliers, as referred to herein, are responsible for managing their contractor resources to fulfill the client's resource requirements. A staffing supplier manages a private contractor resource pool to fulfill client skill requirements. Administrators, as referred to herein, are responsible for maintaining the skills procurement system. Administrators can define user privileges and system-wide attributes.

In various embodiments, the functionality described is accomplished by hardware and software resident at a location administered by the supplier of the skills procurement platform. The hardware and software is accessed at a client's site.

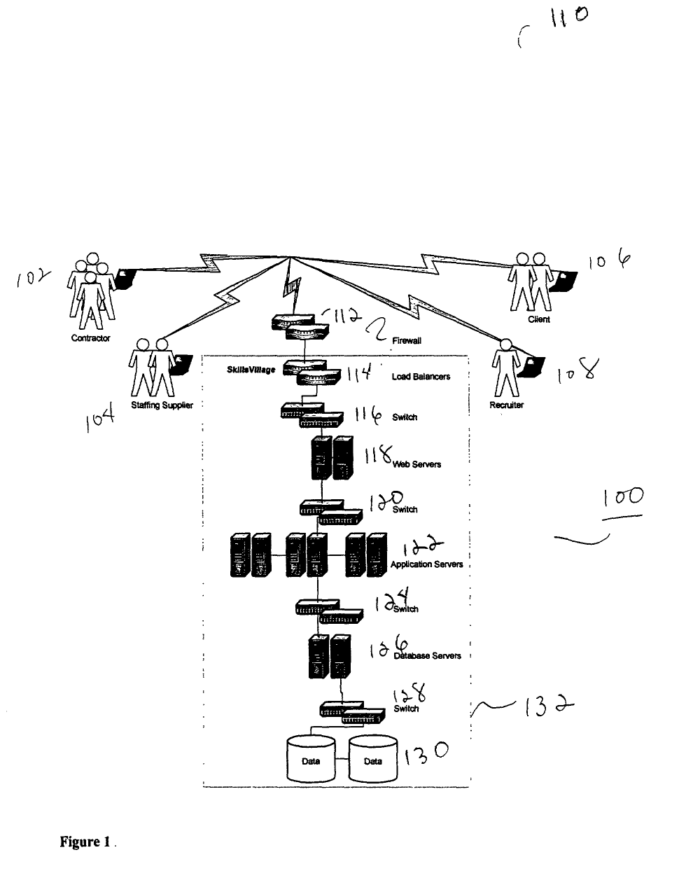

FIG. 1 is a diagram of a dynamic business management system 100 according to one embodiment. Clients 106, contractors 102, staffing suppliers 104, and recruiters 108 access the skills procurement platform 132 through the Internet 110 using a computer. Firewall hardware and software 112 provides security for information exchanged across the extranet presented by the skills procurement platform 132. Skills procurement platform 132 includes load balancers 114, web servers 118, applications servers 122, database servers 126, database 130, and various switches 116, 120, 124, and 128. The skills procurement platform 132 provides many services through a hosted application accessible via an extranet.

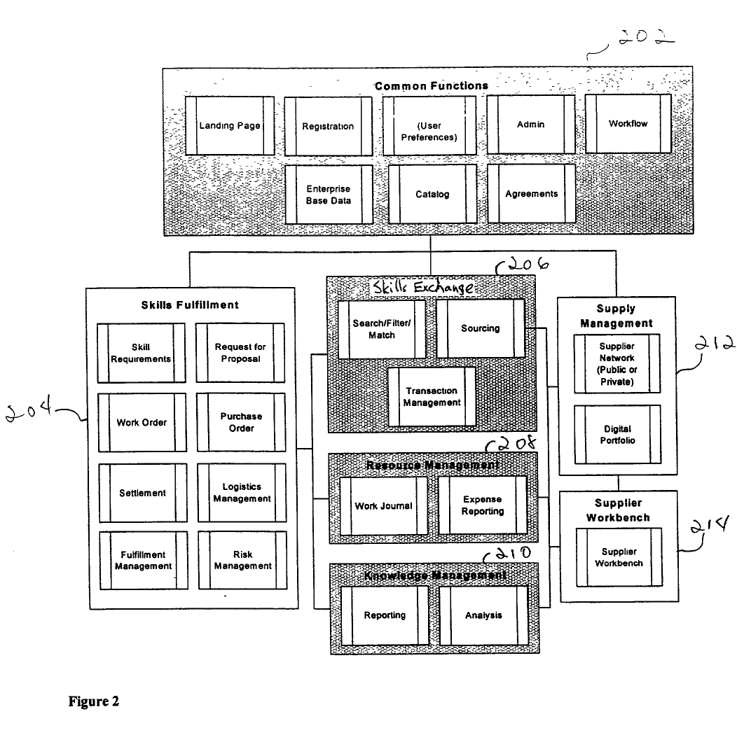

FIG. 2 is a block diagram showing various components of the hosted application accessible through a hosted management server (e.g., application servers 122). The hosted application components allow companies to find and deploy the skilled workers that are right for them, and then helps them contract (hire) those workers quickly and efficiently, creating a simplified, cost effective solution for matching skills to business requirements. The hosted application includes various software modules that perform a variety of functions. The modules include a common functions module 202, a skills fulfillment module 204, a skills exchange module 206, a resource management module 208, a knowledge management module 210, a supply management module 212, and a supplier workbench 214.

Common functions 202 encompass a suite of application functionality that is used to enable the hosted application. These functions are not specific to a user function or role and include: landing page, registration, user preferences, administration, workflow, enterprise base data, catalog, and agreements.

The landing page is the main page that is accessed from the web browser from which the hosted application is initiated. The landing page is configurable with graphics to provide a customized client experience, and enables links to other providers designated by the client.

Registration provides the ability to define user attributes. A user name and password are created to provide user access to the application environment and to define the user experience. The user registration catalogs attributes such as name, cost center, department, security and permissions. Attributes may also be changed at a later time, either by a user, or automatically in response to other data. Attributes determine a user's level of access and role within the modules of the application.

User preferences provides the ability to personalize the user experience. Users can configure the look and feel of the application. A user can define which application modules are available in their work area and can configure those applications to meet user-specific business requirements. The configuration options may be standard available or may vary by module. A user can, for example, configure the work journal to determine the start day for the workweek for time entry and can change from a detailed to a summary entry form. User preferences are be available at different levels of access. For example, only an enterprise manager or administrator can set certain preferences at an enterprise-wide level, while other preferences are changeable by individuals with lower levels of access.

The administration component provides the ability to define system-wide attributes. The application environment can be configured to use the terminology commonly referenced by the enterprise and information, such as roles, skill types, experience levels, and titles may be maintained. Users may be added and authorizations configured. Access to system-wide attributes and user functions require system administration level security authorizations.

The workflow component provides the ability to define and configure the workflow for the enterprise. Routing rules can be defined by business process to guide the flow of information within the enterprise. The rules are applied dynamically allowing the enterprise to proactively react to the numerous events that can occur.

Enterprise base data provides the ability to define the enterprise, such as the organization structure, nomenclature, and suppliers and contact information. Enterprise base data is defined for both the public marketplace and the private marketplace or enterprise.

The procurement of skills resources is not an exact science due to the dynamic nature of people and their skills. A job can be well defined with a specific set of skills and attributes required to perform the function. Some jobs, however, require a blend of soft skills that are not easily measured and the exact attributes may be more subjective.

The catalog function facilitates the skill procurement process by providing a categorized hierarchical view of the skills that can be purchased. A catalog may be specific to an industry or an enterprise where the skills can be listed individually, classified by type, or job role. The grouping of skills into roles (e.g., Java developer role) enables a user in the fulfillment process to select a role instead of entering numerous specific skill requirements. The role can also be used as a template, or starting point, for the configuration of a specific skill requirement. A user can select a role and customize its attributes for a specific project. Pricing rules can also be defined in the catalog.

The agreements function defines the way business is conducted within the enterprise and with its suppliers. Agreements define the financial, logistical, and performance metrics used to guide the business process and to measure the effectiveness of the business relationship.

The enterprise typically has a standard agreement form or template that they use with their suppliers. The corporate client uses this template together with additional, supplier-specific information, to develop the agreement between the two parties. The agreements function facilitates the generation of agreements by providing the ability to define agreement templates and to generate agreements based on the agreed upon terms and conditions. The information entered online in the agreements function can be used to populate the required information in the agreement template and the agreement can then be printed. In addition to standard agreements, the ability to attach a customized agreement is available.

Pricing and discount methodologies may be defined by the enterprise to accommodate the varying types of pricing arrangements that can be made between the enterprise and a supplier, such as: a percentage markup, volume pricing and discounts, and fixed pricing. The most common pricing methodology is a percentage markup where the supplier is allowed to charge a percentage above cost. Volume pricing provides a decreasing price or increasing discount the more that is purchased. Fixed pricing is typically used for commodity type skills where there are an abundance of resources and the skill set is well defined. Prices or price factors may be defined by skill or job function.

Agreements govern the fulfillment process by defining the workflow required between the enterprise and its suppliers. The fulfillment process can be configured and steps included or excluded based on the requirements of a given supplier or business process. For example, depending on the engagement, work order approval may or may not be required prior to the hire. The workflow can be configured to require specific approval steps and routing for documents within the fulfillment and work management processes.

Logistical information, such as payment terms, insurance coverage required, and indemnifications are also specified as a part of an agreement.

Performance metrics can be defined for agreed upon response times, minimum buying requirements, and contractor performance. The performance against these predefined metrics can be monitored through the use of sophisticated reporting and analysis tools.

The skills fulfillment module provides functionality for the hiring manager and recruiter to source, fulfill, and monitor the skills procurement process. Users can enter skill requirements or create requests for proposal (RFPs) and source the requirements using the skills exchange. Once a match has been found and a contractor selected, a work order can be created to document the terms and conditions of the project. An approved work order can then be used to generate a binding purchase order (PO).

The skills requirements area provides the ability for a hiring manager or recruiter to enter skills requirements to source a specific job or jobs. Multiple skills and experience levels, preferred rate information, job duration and location can be entered creating a job profile or project requirement. The catalog can be perused to facilitate the creation of the project requirement. The hiring manager or recruiter can search through the catalog and select a role with similar skills and configure the role using the catalog as a starting point or template. Skill requirements can be entered for both current and future project requirements.

Once the skill requirements have been entered, the hiring manager or recruiter can utilize the skills exchange to source their requirements. Automatic searches can be used to fulfill the skills requirement. In addition, the skills requirement can be broadcast for review and bid. Bargaining and bidding can be conducted based upon responses to the skills request, including auctions and reverse auctions.

The request for proposal module provides the ability for a hiring manager or recruiter to enter project requirements. An RFP is a request to source an entire project or team of individuals. Hiring managers or recruiters can model a project team with multiple skill requirements in multiple locations and possibly for differing time periods. The requirement may include the ability to totally outsource the project team and project deliverables. The RFP is sourced and approved as a whole and is not approved based on a single skill requirement or role. The catalog can be perused to facilitate the creation of the project requirements. The hiring manager or recruiter can search through the catalog and select a role with similar skills and configure the role using the catalog as a starting point or template. Skill requirements can be entered for both current and future project requirements.

Once the RFP has been entered, the hiring manager or recruiter can utilize the skills exchange to source their project team. Automatic searches can be used to fill the RFP. In addition, parts of the RFP can be broadcast for review and bid. Bargaining and bidding can be conducted based upon responses to the request for proposal, including auctions and reverse auctions.

The work order area provides the capability of capturing the terms of the negotiation process between the hiring manager or recruiter and the contractor. The work order is not a contractually binding document until approved by both parties. The work order is specific to an individual or team of individuals and captures the skills requirements, contractor names, rates, duration, locations, and job responsibilities. For future scheduled skills requirements or RFPs, contractual arrangements may be defined to bind both parties given the instability and predictability of the resource availability and project requirements. A work order is also known as a statement of work.

The payment terms specified on a work order may be configured and a skill requirement and an RFP can have very different payment methodologies. A work order for a skills requirement specific to an individual is typically invoiced on an hourly basis. The individual submits time and project information using the work journal and is paid based on the hours worked. In the RFP or project environment, however, various payment methodologies may be used. Payment can be on a time and material basis similar to the payment terms of a skills requirement or they can be based on the progress of the project or at specific milestones within the project.

The purchase order is a legal binding document between a corporate client and a contractor. A purchase order is created once a work order has been approved and is a signal to both the hiring manager and the contractor that all terms of the project have been agreed upon and that the work may begin.

As with the work order, the purchase order specifies the financial, logistical, and performance aspects of the engagement. The client's accounting department references the purchase order when making payments to contractors for time or deliverables. The projects consume the money specified in the purchase order when time is reported or progress is reported against a project and approved using the work journal. The purchase order would need to be amended or an additional purchase order generated if the terms of the project were to change, such as if the project were to be extended or the rates were to be changed.

There are multiple activities that must be performed to complete the hiring process and to prepare the enterprise and overall work environment for the contract worker. The logistics management component provides the capability to facilitate the logistical components of the hiring process and includes activities, such as the management of blood testing, badging, and facilities.

The settlement function tracks expenditures on a project and provides a view of all outgoing expenditures. The work journal (as described more fully below) forms the basis of the expenditure by providing a view of all approved work along with the related rate and associated expenses. A record of the payments made against the work journal is maintained by the settlement function.

Fulfillment management provides the ability for the hiring manager or recruiter to manage the fulfillment process. Skills and project requirements are reviewed and monitored for completeness and routed back to the requestor if additional information is required. Once a requirement has been qualified, it can be submitted to the skills exchange and routed to specific suppliers in the supplier network.

The fulfillment management process provides the ability to notify a requestor of the status of open requirements, including the number of requirements filled, requirements submitted for sourcing, and summary of the supplier submittal status. The agent function can also broker the fulfillment process by qualifying questions such as asking for rate increases or skill qualifications. A client-hiring manager can respond to notifications provided by the agent function indicating a change in a requirements priority or additional tasks for the agent to perform.

The risk management component provides the ability to assist with the pre-qualification of a contractor or consultant and to monitor the compliance with government rules and regulations. As a part of the assessment, a background check function is provided that provides the ability to verify, for example, employment, education, and criminal history.

Supplier management aggregates a company's contingent workforce supply resources, including staffing firms, job boards, and other exchanges—creating a centralized, cost-effective supply network.

The supplier network function provides the ability to define the suppliers used to fulfill skills or project requirements. The supplier network may include a private marketplace, which is an enterprise-specific marketplace that is only accessible to the corporate client for whom it was created. The private marketplace includes multiple staffing suppliers and associated consultant rosters. The supplier network can also be extended to encompass the public marketplace enabling the corporate client access to the public marketplace when skills requirements cannot be fulfilled within their own private supplier network.

Suppliers must be registered to participate in a corporate client's private marketplace. The terms of the agreement between the enterprise and the supplier can be captured in the agreements module, which defines the way business is conducted within the enterprise and with its suppliers. Suppliers can manage a consultant roster and create a digital portfolio for each of their consulting resources. They can provide detailed portfolio information to facilitate the skills exchange or limit the digital portfolio to summary-level information only with an attached resume. If only summary information is provided, the reliance is on the staffing supplier to source the project requirements since the information necessary to provide a detailed search within the skills exchange is not available.

The digital portfolio provides the ability to capture contractor information online. Information, such as skills and proficiencies, education, affiliations, work history, and personal preferences can be captured within the digital portfolio and used by the skills exchange to source skills or project requirements. A resume can also be attached to the digital portfolio to provide a personalized view of the consultant's background and experiences.

Additionally, the ability to capture work-related performance metrics for each contractor is available. These metrics are collected during the work management process as managers rate their contractor's performance. Additional metrics can be collected from the project team to provide a full view of the contractor's performance on a project. These metrics can be held privately by the contractor or can be exposed to potential clients depending on the preference of the contractor.

Given the dynamic nature of a contractor's skills and proficiencies, it is important that the digital portfolio be updated when a consultant finishes a project. The digital portfolio should be updated to incorporate any new skills attained during the engagement and any additional proficiency levels achieved. To ensure that the digital portfolio is current, the contractor has the capability of automatically updating their digital portfolios at the end of each engagement.

The supplier workbench module provides the ability for the staffing supplier to manage their “bench”, or collection of workers not currently employed. The supplier workbench enables the staffing supplier and provides tools for the supplier to profile their consultants and to manage their ongoing work efforts. Included in the supplier workbench is a billing function that enables a supplier to provide invoices for the enterprise.

Skills exchange is the trading nexus to facilitate the efficient exchange of contract worker supply and job requirements. An efficient collaboration platform for managing the multi-party relationships and communications inherent in the contingent workforce procurement process, the skills exchange brings together the community of hiring managers, recruiters, staffing agencies and contractors to conduct the hiring transaction, improve real-time communication and eliminate lag time and transaction costs.

The search, filter, match function provides the ability for a hiring manager or recruiter to search through the supplier network for qualified contractors to match skills or RFP requirements. The search function provides dynamic filtering based on user behavior. Preferences can be specified and skills can be prioritized to provide a more refined set of search requirements.

There are many attributes and sourcing rules used to determine which staffing suppliers are used to source a project requirement. Staffing suppliers may focus on a specific locale or specialize in specific skills. Clients may have company preferences or agreements that define their preference for sourcing their project requirements. The sourcing function provides the ability for the client to source their project requirements. Sourcing rules may be defined and agreements referenced to ensure contractual obligations are met. Sourcing preferences define the organization's sourcing policies as well as the communication methodology used to communicate to each supplier. Sourcing preferences can be applied automatically or manually during the skills fulfillment process. The sourcing action initiates communication between the client-hiring manager or recruiter and the resource coordinator for the selected staffing suppliers.

Transaction management provides workflow to manage the sourcing, interview, and negotiation process. Hiring managers can notify eligible contractors about upcoming project opportunities. E-mail is sent to the contractor and the contractor can respond directly to the hiring manager's request using the skills exchange. Interview comments, questions, and concerns can be captured during the ongoing communication exchange and the status of the opportunity updated. If the interview and negotiation process is unsuccessful, the opportunity can be terminated and the communication loop closed. Once a match is found a work order can be created.

Transaction history is maintained, including the capture of status information as the transaction progresses from inquiry through hire.

The resource management module encompasses the functions for monitoring the ongoing work activities and includes work journal processing and expense reporting. Resource management provides collaboration between the contractor and the hiring manager regarding all aspects of the engagement.

The work journal is the collaboration vehicle for ongoing project activities and provides the ability for the contractor and hiring manager to communicate regarding project details. The work journal enables the contractor to record and submit time sheets to the project manager for immediate, online approval. The contractor can also track daily activities and progress, and report problems or issues. All of the information in the work journal is dynamically captured in the contractor's digital portfolio, so personal skills inventory and project history is always up to date. The hiring manager can provide feedback to the contractor, including performance-rating information through the approval process. The work journal provides a variety of capabilities, including: recording the number hours worked on a project and submission of hours to the project manager for approval; recording and reporting project-related problems or issues to the project manager; summarizing all of the information entered to create a comprehensive project report; and recording performance information regarding a contractor's performance on a project. Electronic approvals provide the ability for the client-hiring manager to electronically approve work journals. The use of electronic signatures further secures the transaction by ensuring that the approver is who they say they are.

To provide a complete view of the contractor's performance, a 360-review process is supported. Coworkers, subordinates, and other hiring managers can review and rank a contractor's performance and the performance information is captured within the contractor's digital portfolio.

The expense reporting function provides the capability to capture travel and expense information relating to a project. A contractor can enter expenses incurred on a project and submit it to the project manager for approval.

Knowledge management provides a suite of tools and services to help companies manage, measure, and analyze the performance of their contractors, suppliers, and business processes for the contingent workforce. The knowledge management solution accumulates process knowledge and costs across all aspects of the skills procurement lifecycle. This knowledge is compounded exponentially, bringing continuous improvements and shared learning to all participants in the process. The data mining and analytic capabilities drive new levels of efficiency by uncovering hidden costs and purchasing patterns for helping hiring managers, recruiters and their suppliers make smarter, more informed skills hiring and deployment decisions.

Analytical tools provide the ability for the client-executive to define performance metrics to monitor the skills fulfillment process. A dashboard of metrics can be defined with custom workflow and notification sequences to notify the executive when events occur. The objective of the analysis function is to facilitate the role of the client-executive by providing information when and how required. The dashboard can be configured, for example, to show all metrics regardless of value or it can be configured to only show metrics out of tolerance.

The reporting area provides both standard and customized reporting capabilities for the corporate client. Standard reports have been defined to cover the most common user requirements. Customized ad hoc reports can be created to satisfy the specific needs of the enterprise or user.

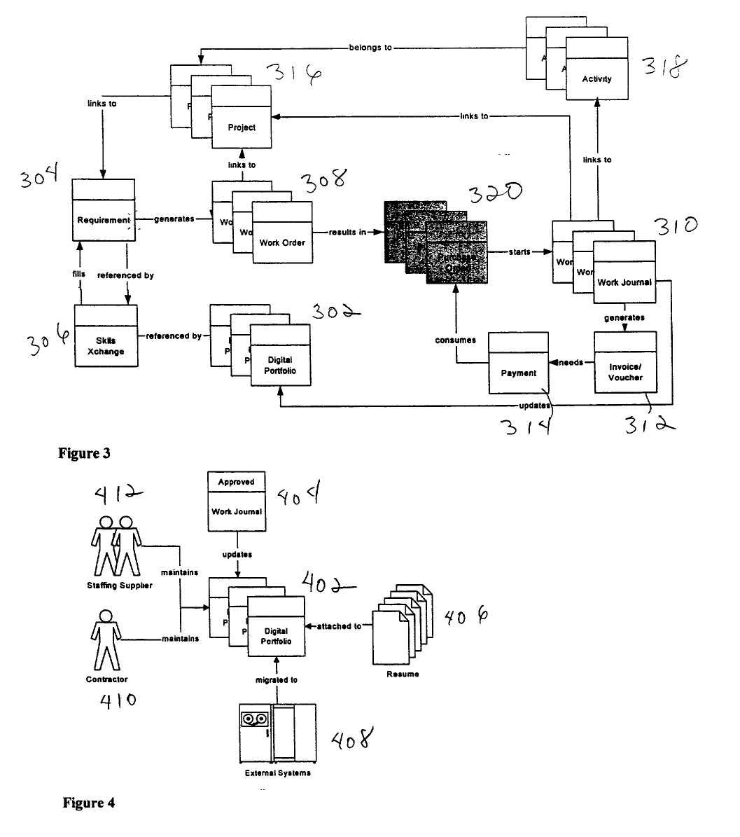

FIG. 3 is a entity relationship diagram showing the internal and external entities involved in the procurement and administration of a contingent workforce using the skills procurement platform. FIG. 3 further shows how various modules interact with the entities. An entity is a group of related data that is used and/or generated by one or more of the modules shown in FIG. 2. FIG. 3 is an example of how entities are related in one example scenario. In the example, a requirement 304 is generated to define staffing requirements. The requirement 304 is typically generated by a manager or recruiter who is an employee of a client enterprise. The requirement 304 links to a project 316 that specifies various requirements. The requirement 304 is referenced by the skills exchange module 306, for example, for the purpose of performing a search. The skills exchange module 306 may reference multiple digital portfolios 302.

When the requirement 304 is filled, a work order, or multiple work orders 308 are generated. This results in the generation of a new purchase order (PO) 320 or reference to an existing PO 320. When work on the project begins, a work journal 310 is linked to the activity 318 performed by the contractor. The work journal 310 is also referenced to generate an invoice/voucher 312 which is referenced by payment, or payment module 314. The work journal 310 and the digital portfolio 302 communicate, in part for the purpose of updating the digital portfolio as work progresses on the project.

Additional entities such as the project, activity, and purchase order are also represented in the entity diagram to provide a complete picture.

The individual processes associated with the primary entities are illustrated in more detail in the figures that follow.

FIG. 4 is a diagram that illustrates an example lifecycle of a digital portfolio 402. The digital portfolio 402 contains information related to the education, experience and skills of a participating contractor.

A digital portfolio 402 is initially created either manually by the staffing supplier 412, by the contractor 410, or electronically through data migration from an external system 408. Resumes 406 may be attached to an individual's portfolio to provide additional information and streamline the data entry process. Once a digital portfolio has been created, it will be continually updated by the work journal 404 to reflect new skills and experience gained as a result of work assignments.

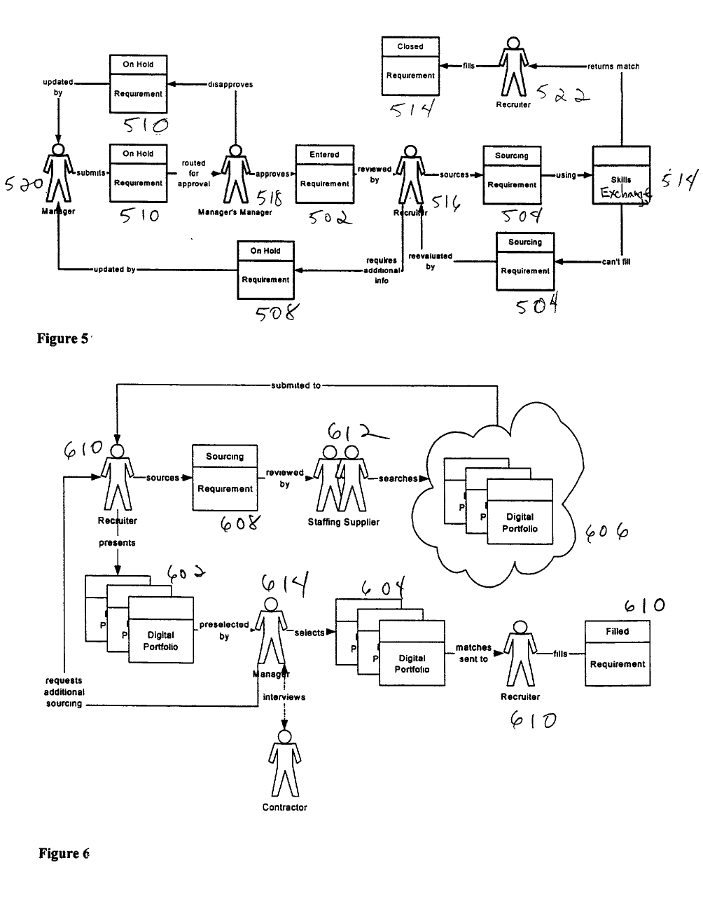

FIG. 5 is a process flow diagram that illustrates an example requirements fulfillment process. A requirement represents an individual job description, including information such as the skills needed, the time frame, billing information, logistics and the price offered.

The requirements fulfillment process begins when a hiring manager 520 posts a job requirement 510. The requirement 510 is approved or disapproved by a higher manager 518. If the requirement 510 is approved, it is routed to a recruiter 516 for review 502. The recruiter 516 subsequently broadcasts all valid sourcing requirements 504 to staffing suppliers for sourcing. The staffing suppliers then use the skills exchange 514 to source, match and manage fulfillment of the requirement 504 from among the participating contractors. If the requirement 504 cannot be filled, it is returned to the recruiter 516 for reevaluation. If a match is found using the skills exchange 514, the recruiter 522 closes the requirement 514.

FIG. 6 is a process flow diagram showing more detail of the skills exchange 514. The skills exchange 514 manages the process of sourcing, matching and managing open job requirements and available contingent workers. Matching is performed based on a comparison of the criteria defined for the requirement and the attributes associated with the digital portfolios of the workforce.

The skill exchange process begins when the recruiter 610 presents a requirement 608 to the staffing suppliers 612. The staffing suppliers 612 then use the skills exchange to search for applicable digital portfolios 606. The digital portfolios of all available contingent workers meeting the specifications are submitted to the recruiter 610 for consideration. The recruiter 610 reviews the portfolios submitted and presents the appropriate digital portfolios 604 to the hiring manager 614. The hiring manager 614 interviews the candidates and selects the one who is best suited to fill the requirement.

The skills exchange also keeps a history of all notifications, bids, and responses for participating contractors and clients.

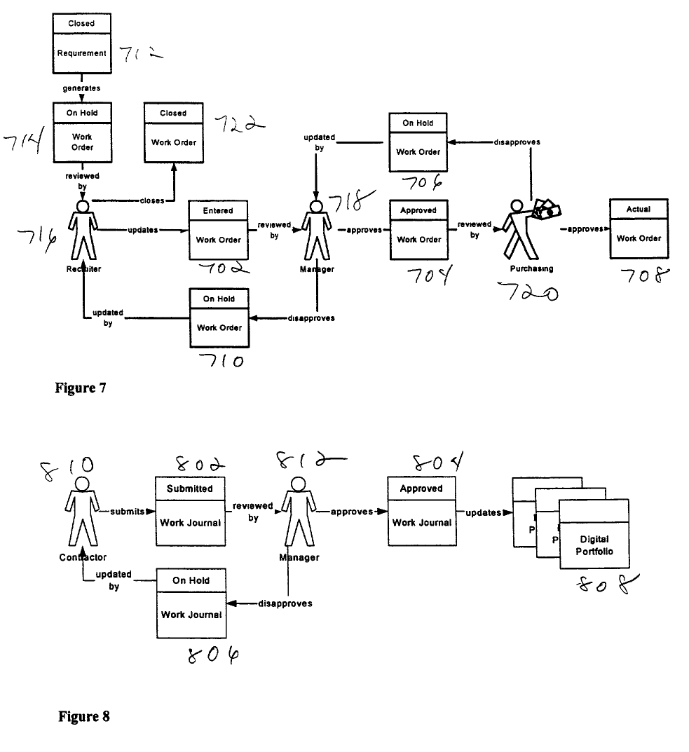

FIG. 7 is a process flow diagram that illustrates a typical work order approval process. The work order contains the basic terms and conditions related to a job, such as the specific individuals involved and the actual rate and timeframe for those individuals. The work order can create or reference a project.

The work order approval process begins with the recruiter 716 receives work orders 714 that results from the requirement 712. The recruiter 716 enters the work orders 702 for review by the hiring manager 718. Approved work orders 704 are forwarded to the purchasing department 720 for review and approval. Any disapproved work orders 706 are returned to the hiring manager 718 or recruiter 716 for update or correction. Contractors can be pre-registered so that as soon as the work order is approved, they are officially registered in the skills exchange. The recruiter 716 also closes work orders 722.

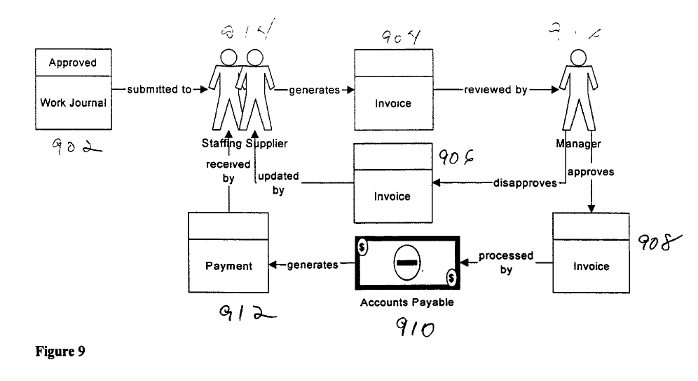

FIG. 8 is a process flow diagram that shows an example work journal approval process. The work journal is a record of the time that a contractor spends on an assignment, including the related activities that have been performed.

The work journal approval process begins when the contractor 810 submits his work journal 802, including a weekly time and progress log, along with any project issues, to the hiring manager 812 for review and approval. Approved work journals 804 will automatically update the digital portfolio of the contractor 810 to reflect any new skills or experience gained as a result of the work performed. Any disapproved work journals 806 are returned to the contractor 810 for update or correction.

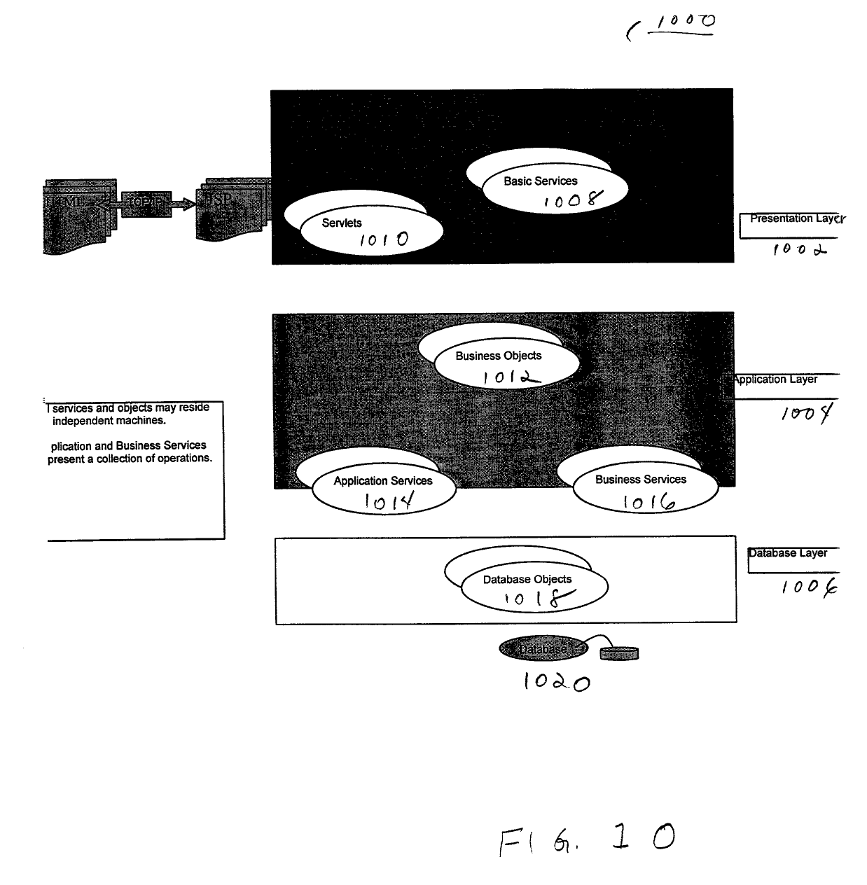

FIG. 9 is a process flow diagram that illustrates a settlement process. Settlement refers to the creation and payment of invoices related to the work performed by a contractor.

The settlement process begins when an approved work journal 902 is submitted to the staffing supplier 914 for generation of an invoice 904. The invoice 904 is forwarded to the hiring manager 916 for review and approval. Approved invoices 908 are then forwarded to accounts payable 910 for processing. Payments 912 generated by accounts payable are sent to the staffing supplier 914 to settle the invoice. Any disapproved invoices 906 are returned to the staffing supplier 914 for update or correction.

FIG. 10 is a block diagram of one embodiment of an architecture 1000, including the hosted application, or extranet. The hosted application includes a set of computing services that are broken into three distinct layers. The presentation layer 1002 acts as the main controller for the hosted application and includes servlets 1010 and basic services 1008. The presentation layer 1002 manages incoming requests and helps to prepare outgoing requests. The application layer 1004 includes business objects 1012, application services 1014, and business services 1016. The business objects 1012 provide the core processing for requests, and leverage application services and business services for specialized tasks. The application services 1014 or business services 1016 may represent and abstract the interface to a complex application for workflow, reporting, trading, etc. The database layer 1006 provides a consistent interface to manipulate data elements, and includes database objects 1018. The database layer 1006 is relied upon by the application layer 1004 and the presentation layer 1006.

The architecture 1000 is based on the Java 2 Enterprise Edition standard. The hosted application relies on an application framework to provide additional configuration and flexibility. Specifically, the hosted application includes a set of controls to manage different version of objects and services. Additionally, the hosted application relies on a set of data control tables to drive the behavior of the entire system. This application framework provides powerful capabilities and provide for changes in system behavior via changes by the end user through hypertext markup language (HTML) based forms without changes in the programming code itself.

The hosted application is accessed via a user's computer. The end user relies on his or her browser to make a request to the hosted application. When a user makes a request (via HTML using the TCP/IP transport on the Internet), the hosted application performs a number of actions to fulfill and process the request.

The hosted application captures the request at a Java servlet. The Java servlet will interpret the request and dispatch the request to basic services for security checking, validating the content of the request, etc. When the request is determined to be valid in the presentation layer 1002, the request will be dispatched to a business object 1012.

The business object 1012 will interpret the incoming request and determine how to appropriately process the request. The business object 1012 may invoke an application service 1014 or business service 1016 to process the request. The business object 1012 may invoke other business objects 1012 to process the request. The handling of the request in the business object 1012 or application layer 1004 will be determined by a large number of attributes that are configurable by an administrator or end user. For example, the business object 1012 may determine how to process a request based upon the user's association to an organization or the user's role or security within the hosted application. In other cases, the business object 1012 relies on application services 1014 or business services 1016 (e.g., workflow, reporting, etc.) to process an aspect of the request. The business object 1012 will access the control data when the request is made to determine how to appropriately process the request.

Business objects 1012, application services 1014, and business services 1016 may rely on database objects 1018 to either store or retrieve data elements. The qualification of how to access the data store will be provided by the service or object that makes the request. The data store itself will electronically capture any changes to the data elements.

The invention has been described with reference to specific embodiments. The invention is not limited to the embodiments described, but is defined by the following claims.

What is claimed is:

1. A method for workforce procurement and management using a hosted network application, the method comprising:
maintaining a plurality of modules accessible at varying levels to different participants in a workforce procurement and management process, the modules comprising,
an exchange module comprising a search function;
a skills fulfillment module comprising,
a skills requirement function for specifying skills required for a project; and
a settlement function for tracking expenditures on a project;
resource management module comprising a work journal function for collecting information about the activity of an individual contractor;
a knowledge management module comprising a reporting function and an analysis function; and
maintaining a database coupled to the plurality of modules.

2. The method of claim 1, wherein the exchange module further comprises:
a sourcing function for specifying sourcing preference and rules for a project; and
a transaction management function for managing a hiring process including sourcing, interviewing, and negotiation.

3. The method of claim 1, wherein the skills fulfillment module further comprises:
a request for proposal (RFP) function for entering an RFP;
a work order function for documenting terms and conditions of a project;
a purchase order function for generating a purchase order in response to an approved work order;
a logistics management function for facilitating the logistical components of a hiring process including management of blood testing, badging, and facilities;
a fulfillment management function for managing the fulfillment of sourcing requirements, including maintaining a status of sourcing requirements.
a risk management function for facilitating the pre-qualification of a contractor and a consultant and for monitoring compliance with government rules and regulations.

4. The method of claim 1, wherein the resource management module further comprises an expense reporting function.

5. The method of claim 1, wherein the plurality of modules further comprises:
a supply management module comprising a supplier network function and a digital portfolio function;
a supplier workbench module comprising a supplier workbench function; and
a common functions module comprising:
an administration function;
a workflow function;
a catalog function; and
an agreements function.

6. The method of claim 1, wherein the different participants include a contractor who is an individual contingent worker, a client who is an employee of an enterprise, a recruiter who sells a service of finding contingent workers, and a staffing supplier who sells a service of finding contingent workers, including finding multiple contingent workers to staff a project.

7. The method of claim 6, wherein the participant includes a contractor, a staffing supplier, and a recruiter, and wherein the predetermined criteria includes a list of staffing suppliers, and a list of skills, and wherein the predetermined criteria are generated by the analysis function.

8. The method of claim 7, wherein the different participants have varying levels of access to the hosted network application based upon attributes, wherein attributes include personal attributes associated with a participant, and enterprise attributes associated with an enterprise using the hosted network application.

9. The method of claim 1, wherein the work journal function comprises:
the contractor entering data into a work journal data entity, wherein the entered data comprises,
hours worked;
type of work done; and
comments regarding work done;
a client who is a manager reviewing the work journal data entity;
the manager approving the work journal data entity; and
the manager entering comments into the work journal data entity.

10. The method of claim 5, wherein the digital portfolio function comprises:
populating a digital portfolio data entity with data extracted from an electronic resume;
populating the digital portfolio data entity with data from systems external to the hosted network application; and
automatically updating the digital portfolio data entity with data from the work journal data entity.

11. The method of claim 1, wherein the search function comprises;
performing a search for a contractor based upon predetermined criteria entered by a participant;
performing a search for a contingent position based upon predetermined search criteria entered by the participant;
searching the database, including searching a plurality of digital portfolio data entities; and
searching a plurality of public databases that are not part of the hosted application.

12. The method of claim 3, wherein the work order function comprises;
a participant generating a work order based upon a successful search for a contractor;
at least one participant reviewing the work order at least one level in order to determine whether to approve the work order;
if the work order is not approved, returning the work order to a level below the level at which it was not approved; and
collecting data regarding the work order, approval, and failure to approve in the database, wherein the knowledge management module accesses the collected data.

13. The method of claim 12, wherein the work order function further comprises associating a purchase order with the work order when the work order is approved.

14. The method of claim 1, wherein the settlement function comprises:
submitting the approved work journal of a contractor to a staffing supplier associated with the contractor;
generating an invoice;
submitting the invoice to the manager for approval;
is the invoice is approved submitting the invoice to accounts payable for processing;
storing data regarding the settlement function in the database, wherein the knowledge management module accesses the stored data.

15. The method of claim 3, wherein the request for proposal function comprises:
receiving a request for proposal including a list of required contingent workers and their associated skills;
linking the request for proposal with a project specification that includes data regarding a project to be staffed;
generating a search based upon the request for proposal and the project specification, wherein the search uses the exchange module;
broadcasting at least part of the request for proposal to publicly accessible applications;
receiving responses to the request for proposal;
conducting bargaining based upon responses to the request for proposal including auctions and reverse auctions.

16. The method of claim 1, wherein the reporting function comprises generating at least one report using data including data generated by the plurality of modules and stored in the database.

17. The method of claim 1, wherein the analysis function comprises:
automatically performing an analysis of at least one report based upon criteria selected by a participant; and
the participant changing at least one attribute based upon a review of the analysis.

18. The method of claim 1, wherein the hosted network application is hosted on the Internet.

19. A system for workforce procurement and management using a hosted network application, comprising:
a plurality of web servers for hosting a workforce procurement and management application;
at least one database server;
at least one database for storing a plurality of data including the workforce procurement and management application, wherein the workforce procurement and management application includes a plurality of modules accessible at varying levels to different participants in a hosted workforce procurement and management process, the modules comprising,
an exchange module comprising a search function;
a skills fulfillment module comprising,
a skills requirement function for specifying skills required for a project; and
a settlement function for tracking expenditures on a project;
resource management module comprising a work journal function for collecting information about the activity of an individual contractor;
a knowledge management module comprising a reporting function and an analysis function; and
maintaining a database coupled to the plurality of modules.

20. The system of claim 19, wherein the exchange module further comprises:
a sourcing function for specifying sourcing preference and rules for a project; and
a transaction management function for managing a hiring process including sourcing, interviewing, and negotiation.

21. The system of claim 19, wherein the skills fulfillment module further comprises:
a request for proposal (RFP) function for entering an RFP;
a work order function for documenting terms and conditions of a project;
a purchase order function for generating a purchase order in response to an approved work order;
a logistics management function for facilitating the logistical components of a hiring process including management of blood testing, badging, and facilities;
a fulfillment management function for managing the fulfillment of sourcing requirements, including maintaining a status of sourcing requirements.
a risk management function for facilitating the pre-qualification of a contractor and a consultant and for monitoring compliance with government rules and regulations.

22. The system of claim 19, wherein the resource management module further comprises an expense reporting function.

23. The system of claim 19, wherein the plurality of modules further comprises:
a supply management module comprising a supplier network function and a digital portfolio function;
a supplier workbench module comprising a supplier workbench function; and
a common functions module comprising:
an administration function;
a workflow function;
a catalog function; and
an agreements function.

24. The system of claim 19, wherein the different participants include a contractor who is an individual contingent worker, a client who is an employee of an enterprise, a recruiter who sells a service of finding contingent workers, and a staffing supplier who sells a service of finding contingent workers, including finding multiple contingent workers to staff a project.

25. The system of claim 24, wherein the participant includes a contractor, a staffing supplier, and a recruiter, and wherein the predetermined criteria includes a list of staffing suppliers, and a list of skills, and wherein the predetermined criteria are generated by the analysis function.

26. The system of claim 25, wherein the different participants have varying levels of access to the hosted network application based upon attributes, wherein attributes include personal attributes associated with a participant, and enterprise attributes associated with an enterprise using the hosted network application.

27. The system of claim 19, wherein the work journal function comprises:
the contractor entering data into a work journal data entity, wherein the entered data comprises,
hours worked;
type of work done; and
comments regarding work done;
a client who is a manager reviewing the work journal data entity;
the manager approving the work journal data entity; and
the manager entering comments into the work journal data entity.

28. The system of claim 23, wherein the digital portfolio function comprises:
populating a digital portfolio data entity with data extracted from an electronic resume;
populating the digital portfolio data entity with data from systems external to the hosted network application; and
automatically updating the digital portfolio data entity with data from the work journal data entity.

29. The system of claim 19, wherein the search function comprises;
performing a search for a contractor based upon predetermined criteria entered by a participant;
performing a search for a contingent position based upon predetermined search criteria entered by the participant;
searching the database, including searching a plurality of digital portfolio data entities; and
searching a plurality of public databases that are not part of the hosted application.

30. The system of claim 21, wherein the work order function comprises;
a participant generating a work order based upon a successful search for a contractor;
at least one participant reviewing the work order at least one level in order to determine whether to approve the work order;
if the work order is not approved, returning the work order to a level below the level at which it was not approved; and
collecting data regarding the work order, approval, and failure to approve in the database, wherein the knowledge management module accesses the collected data.

31. The system of claim 30, wherein the work order function further comprises associating a purchase order with the work order when the work order is approved.

32. The system of claim 19, wherein the settlement function comprises:
submitting the approved work journal of a contractor to a staffing supplier associated with the contractor;
generating an invoice;
submitting the invoice to the manager for approval;
is the invoice is approved submitting the invoice to accounts payable for processing;
storing data regarding the settlement function in the database, wherein the knowledge management module accesses the stored data.

33. The system of claim 21, wherein the request for proposal function comprises:
receiving a request for proposal including a list of required contingent workers and their associated skills;
linking the request for proposal with a project specification that includes data regarding a project to be staffed;
generating a search based upon the request for proposal and the project specification, wherein the search uses the exchange module;
broadcasting at least part of the request for proposal to publicly accessible applications;
receiving responses to the request for proposal;
conducting bargaining based upon responses to the request for proposal including auctions and reverse auctions.

34. The system of claim 19, wherein the reporting function comprises generating at least one report using data including data generated by the plurality of modules and stored in the database.

35. The system of claim 19, wherein the analysis function comprises:
automatically performing an analysis of at least one report based upon criteria selected by a participant; and
the participant changing at least one attribute based upon a review of the analysis.

36. The system of claim 19, wherein the hosted network application is hosted on the Internet.

37. An electromagnetic medium containing executable instructions which, when executed in a processing system, cause the system to perform workforce management, wherein performing workforce procurement comprises:
receiving a staffing requirement for a projects;
searching a database of digital portfolios to find at least one suitable contractor for the project;
filling the staffing requirement with the at least one contractor; and
automatically updating a digital portfolio of the at least one contractor using data entered by the at least one contractor and at least one supervisor of the at least one contractor.

38. The electromagnetic medium of claim 37, wherein performing workforce management further comprises maintaining a work journal for the at least one contractor, including automatically updating work journal, using data input by the at least one contractor and at least one supervisor of the at least one contractor regarding job performance of the at least one contractor.

39. The electromagnetic medium of claim 38, wherein performing workforce management further comprises generating payments to the at least one contractor and to third parties using data from the work journal and invoice data entered by a manager.

40. The electromagnetic medium of claim 39, wherein performing workforce management further comprises generating reports regarding the project using data from the work journal.
